(19) United States
(12) Patent Application Publication
(10) Pub. No.: US 2011/0305342 A1
(43) Pub. Date: Dec. 15, 2011

(54) INFORMATION PROCESSING APPARATUS, INFORMATION PROCESSING METHOD AND PROGRAM THEREFOR

(75) Inventor: Kuniyuki Manaka, Tokyo (JP)

(73) Assignee: SONY CORPORATION, Tokyo (JP)

(21) Appl. No.: 13/151,345

(22) Filed: Jun. 2, 2011

(30) Foreign Application Priority Data
Jun. 9, 2010 (JP) P2010-132385

(51) Int. Cl. H04L 9/00; G06F 9/22

(52) U.S. Cl. 380/286

(57) ABSTRACT

Provided is an information processing apparatus including a content encryption section generates a content encrypted with a device key, a first storage section storing board determination information for determining whether the board is a board at the time of shipment or a replacement board, a second storage section capable of storing board specific information used to generate the device key, a third storage section storing apparatus specific information, a recording section associating the board and apparatus specific information each other and recording them through the connection section in the external storage apparatus, and an updating section reading from the external storage apparatus the board specific information associated with the apparatus specific information, and updating content of the second storage section and the board determination information of the first storage section, when the board is determined to be the replacement board on the basis of the board determination information.

### BACKGROUND

The present disclosure relates to an information processing apparatus capable of managed copying contents, an information processing method by the information processing apparatus, and a program therefor.

In recent years, a managed copy (MC) technology has been known that enables recording and copying of contents recorded in recording media such as a Blue-ray Disc (trademark) or the like in a storage section such as a Hard Disk Drive (HDD) or the like, under predetermined conditions. In order for a user's information processing apparatus to copy a content recorded in a recording medium through this managed copy, first the information processing apparatus is connected by way of a network to a server apparatus which manages managed copies, and information necessary for acquisition of a permission to copy the content is exchanged between the information processing apparatus and the server apparatus. Going through the exchange of the necessary information with the user's information processing apparatus, the server apparatus judges validity of the copying permission. Then, the information processing apparatus encrypts the content using an apparatus specific key (device key), and saves the encrypted content as a copied content in the storage section. When playing the copied encrypted content, the information processing apparatus deactivates the encryption with the device key and plays the content. The device key is stored in a storage apparatus on a board of the information processing apparatus.

If the board is replaced due to a repair of the information processing apparatus or the like, the device key stored in the storage apparatus on the board before replacement will be lost. Thus, although the information processing apparatus after the replacement of the board is the same information processing apparatus for the user, the board and the device key stored on the board will differ from those before the replacement. Consequently, a problem occurs that the information processing apparatus after the replacement of the board may not play encrypted contents by the device key stored on the board before the replacement. Under these circumstances, in order for the information processing apparatus after the replacement of the board to play the content managed copied before the replacement of the board, it is common to perform managed copying again by using a new device key.

Thus, in an information processing apparatus of Japanese Patent Application Laid-open No. 2007-195110 (Paragraph [0065], FIG. 6) (hereinafter, referred to as Patent Document 1), there are provided copyright protection Large Scale Integration (LSI) in which Electrically Erasable Programmable Read Only Memory (EEPROM) including a key and key restoration data is provided, and a system board in which EEPROM including key restoration data is provided. When the copyright protection LSI is replaced, the key restoration data is copied from the EEPROM of the system board to the copyright protection LSI after replacement.

### SUMMARY

However, in the method of Patent Document 1, additional EEPROM including key restoration data is necessary. In addition, there should be at least two boards on which EEPROM is provided, and thus an information processing apparatus including only one board may not cope with the method. In addition, when both EEPROM are broken, copying process for key restoration may also be impossible. Further, as the process of copying key restoration data involves manual work such as copying with a specific tool or the like, only a secure service center limited to repairing can handle it.

In view of the above-mentioned circumstances, there is a need for providing an information processing apparatus for which a device key can be restored easily and safely.

According to an embodiment of the present disclosure, there is provided an information processing apparatus including a board in which a plurality of electronic components are provided, a connection section to which an external storage apparatus is detachable, a content encryption section, a first storage section, a second storage section, a third storage section, a recording section, and an updating section.

The content encryption section is provided on the board, and generates an encrypted content by encrypting a content with a device key.

The first storage section is provided on the board as one of the electronic components, and stores board determination information for determining whether the board is a board at the time of shipment or a replacement board.

The second storage section is provided on the board as one of the electronic components, and is capable of storing board specific information which is specific to the board and used to generate the device key.

The third storage section stores apparatus specific information which is specific to the information processing apparatus.

The recording section associates the board specific information and the apparatus specific information each other, and records the board specific information and the apparatus specific information through the connection section in the external storage apparatus connected to the connection section.

The updating section reads from the external storage apparatus connected to the above connection section the board specific information associated with the apparatus specific information stored in the third storage section, and updates content of the second storage section and the board determination information of the first storage section, when the board is determined to be the replacement board on a basis of the board determination information stored in the first storage section.

According to this embodiment, board specific information and apparatus specific information to be used to generate a device key specific to a board before replacement are mutually associated and stored in an external storage apparatus. Consequently, an information processing apparatus to which a board after replacement is mounted can restore the board specific information and generate a device key using the restored board specific information. Therefore, the information processing apparatus to which the board after replacement is mounted can also perform managed copying or play managed copied contents, by using the device key specific to the board before replacement. In addition, as the device key itself is not stored in the external storage apparatus, the device key will not leak from the information processing apparatus. Should the board specific information leak, the device key may not be generated unless the board specific information can be restored. Hence, it is safe.

In addition, as only the information processing apparatus to be recognized by the apparatus specific information stored in the third storage section can restore the board specific information specific to the board before replacement, only the information processing apparatus to be recognized by the apparatus specific information stored in the third storage section can perform managed copying or playing managed copied contents by using the device key specific to the board before replacement.

The updating section makes a determination on a basis of the board determination information stored in the first storage section of the board, every time the external storage apparatus is connected.

As this eliminates the need for user operation serving as a trigger of starting process of restoring the board specific information after the board is replaced, it is highly convenient for users.

The recording section encrypts the board specific information and the apparatus specific information, and records the board specific information and the apparatus specific information as one file in the external storage apparatus.

Encryption of the board specific information and the apparatus specific information to be stored in the external storage apparatus further enhances safety against a leak of the board specific information.

The updating section overwrites the second storage section with second board specific information, with the board specific information stored in the second storage section being as first board specific information and the board specific information read from the external storage apparatus by the updating section being as the second board specific information.

This enables the information processing apparatus to which the board after replacement is mounted also to perform managed copying or play managed copied contents by using the device key specific to the board before replacement.

The updating section adds second board specific information to the second storage section, with the board specific information stored in the second storage section being as first board specific information and the board specific information read from the external storage apparatus by the updating section being as the second board specific information.

This enables the information processing apparatus to which the board after replacement is mounted also to perform managed copying or play managed copied contents by using both the device key specific to the board before replacement and the device key specific to the board after replacement in different ways.

The content encryption section records the encrypted content through the connection section in the external storage apparatus connected to the connection section.

The recording section associates a storage location of the encrypted content, flag information for identifying the board specific information used in generation of the device key used in generation of the encrypted content, and the apparatus specific information specific to the information processing apparatus which generates the encrypted content together, and records the storage location, the flag information, and the apparatus specific information through the connection section in the external storage apparatus connected to the connection section, for each of encrypted contents recorded in the external storage apparatus.

The information processing apparatus further includes an encrypted content decryption section which decrypts the encrypted content recorded in the storage location associated with the apparatus specific information which is stored in the third storage section with the device key which is generated by using the board specific information to be identified on a basis of the flag information associated with the storage location, and restores the content.

According to this embodiment, the encrypted content indicated by the storage location associated with the apparatus specific information stored in the third storage section is decrypted with the device key which is generated by using the board specific information to be identified on the basis of the flag information associated with this storage location, to restore the content. In this manner, even if one information processing apparatus includes a plurality of device keys, a device key can be appropriately selected when decrypting the encrypted content, because the board specific information on which the device key is based can be identified on a basis of the flag information.

According to an embodiment of the present disclosure, there is provided an information processing method by an information processing apparatus including a board on which a plurality of electronic components are provided, a connection section to which an external storage apparatus is detachable, a content encryption section which is provided on the board and generates an encrypted content by encrypting a content with a device key, a first storage section which is provided as one of the electronic components on the board and stores board determination information for determining whether a board is a board at the time of shipment or a replacement board, a second storage section which is provided as one of the electronic components on the board and is capable of storing board specific information which is used to generate the device key and specific to the board, and a third storage section configured to store apparatus specific information specific to the information processing apparatus.

A recording section associates the board specific information and the apparatus specific information each other and records the board specific information and the apparatus specific information through the connection section in the external storage apparatus connected to the connection section.

An updating section reads from the external storage apparatus connected to the connection section the board specific information associated with the apparatus specific information stored in the third storage section, and updates content of the second storage section and the board determination information of the first storage section, when the board is determined to be the replacement board on a basis of the board determination information stored in the first storage section.

According to an embodiment of the present disclosure, there is provided a program causing an information processing apparatus including a board on which a plurality of electronic components are provided, a connection section to which an external storage apparatus is detachable, a content encryption section which is provided on the board and generates an encrypted content by encrypting a content with a device key, a first storage section which is provided as one of the electronic components on the board and stores board determination information for determining whether a board is a board at the time of shipment or a replacement board, a second storage section which is provided as one of the electronic components on the board and is capable of storing board specific information which is used to generate the device key and specific to the board, and a third storage section configured to store apparatus specific information specific to the information processing apparatus, to function:

as a recording section configured to associate the board specific information and the apparatus specific information each other and record the board specific information and the apparatus specific information through the connection section in the external storage apparatus connected to the connection section; and

an updating section configured to read from the external storage apparatus connected to the connection section the board specific information associated with the apparatus specific information stored in the third storage section, and to update content of the second storage section and the board determination information of the first storage section, when the board is determined to be the replacement board on a basis of the board determination information stored in the first storage section.

According to the embodiments of the present disclosure, a device key can be restored easily and safely.

These and other objects, features and advantages of the present disclosure will become more apparent in light of the following detailed description of best mode embodiments thereof, as illustrated in the accompanying drawings.

### BRIEF DESCRIPTION OF DRAWINGS

FIG. 1 is a block diagram showing a hardware configuration of an information processing apparatus;

FIG. 2 is a block diagram showing a functional configuration of the information processing apparatus;

FIG. 3 is a flow chart showing a process of recording contents in an external storage apparatus;

FIG. 4 is a schematic view showing the process of recording contents in the external storage apparatus;

FIG. 5 is a flow chart showing a process of restoring Seed A;

FIG. 6 is a schematic view showing the process of restoring the Seed A;

FIG. 7 is a schematic view showing a process of playing the content recorded in the external storage apparatus;

FIG. 8 is a schematic view showing a process of restoring Seed A;

FIG. 9 is a flow chart showing the process of playing the content recorded in the external storage apparatus; and

FIG. 10 is a schematic view showing the process of playing the content recorded in the external storage apparatus.

### DETAILED DESCRIPTION OF EMBODIMENTS

Hereinafter, embodiments of the present disclosure will be described with reference to the drawings.

### First Embodiment

### Hardware Configuration of Information Processing Apparatus

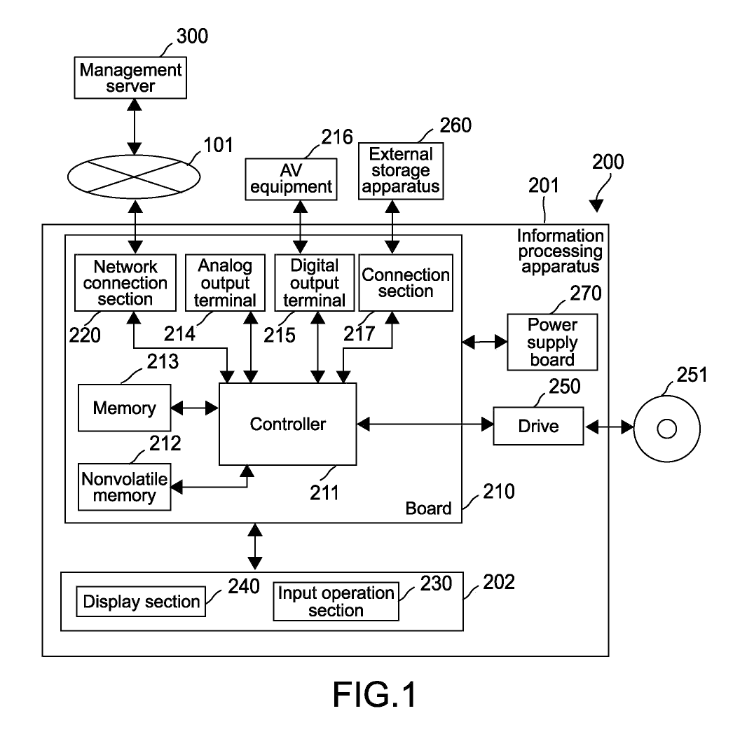

FIG. 1 is a block diagram showing a hardware configuration of an information processing apparatus.

An information processing apparatus 200 is capable of managed copying and includes a record reproducer such as a Blu-ray Disc (trademark) player. The information processing apparatus 200 exchanges information necessary for acquiring a permission to copy a content with a management server 300 through a network 101. When the management server 300 acknowledges validity of copying permission, the information processing apparatus 200 encrypts the content with a device key, and saves the encrypted content in an external storage apparatus. When playing the encrypted content, the information processing apparatus 200 deactivates the encryption with the device key and plays the content.

The information processing apparatus 200 includes a controller 211, a nonvolatile memory 212, a main memory 213, an analog output terminal 214, a digital output terminal 215, a connection section 217, a network connection section 220, an input operation section 230, a display section 240, a drive section 250, and a power supply board 270.

The controller 211, the nonvolatile memory 212, the main memory 213, the analog output terminal 214, the digital output terminal 215, the connection section 217, and the network connection section 220 are implemented on one board 210. The board 210 is removable from a main body 201 of the information processing apparatus 200 and can be replaced. The board 210 is removed from the main body 201 when a device implemented on the board 210 fails, for example. A board 210 after replacement can be mounted on the main body 201 of the information processing apparatus 200.

The connection section 217 is a Universal Serial Bus (USB) connection section, for example, and the external storage apparatus 260 is connected thereto.

The controller 211 not only performs overall control of the respective sections mentioned above but also controls exchange of data among the respective sections. In order to execute software processing to be executed by the information processing apparatus 200, the controller 211 loads a program from the external storage apparatus 260 or the nonvolatile memory 212 to the main memory 213, interprets, and runs it. The controller 211 functions as an encoder and a decoder.

The nonvolatile memory 212 is a firmware for controlling a computer system (hardware) embedded in the information processing apparatus 200 or a rewritable read-only memory which permanently stores information specific to the board 210. The nonvolatile memory 212 is a NAND type flash memory, for example.

The main memory 213 is a memory to be used to load a program code to be executed by the controller 211 or to write program work data. The main memory 213 is a Double-Data-Rate Dynamic Random Access Memory (DDR DRAM), for example.

The analog output terminal 214 and the digital output terminal 215 are interfaces to which Audio Visual (AV) equipment 216 capable of outputting video and audio can be connected. The digital output terminal 215 is a High-Definition Multimedia Interface (HDMI) terminal, for example. The AV equipment 216 is a television set, a monitor, or a speaker, for example. It should be noted that the information processing apparatus 200 may be a Personal Computer (PC) which is integrally formed with the AV equipment 216.

The network connection section 220 is connected through the global network 101 to the management server 300 which manages managed copies, and processes wired or wireless connection with the network 101.

The input operation section 230 and the display section 240 are provided on a front panel 202 of the main body 201 of the information processing apparatus 200. The input operation section 230 includes various keys and the like. A user enters various instructions by using the input operation section 230. An instruction entered in the input operation section 230 by the user is supplied to the controller 211.

The display section 240 is a display apparatus using a Liquid Crystal Display (LCD), an Electro-Luminescence (EL) or the like.

The drive section 250 is a device capable of driving a removable recording medium 251 such as a Blu-ray Disc (trademark) or a Digital Versatile Disc (DVD).

The external storage apparatus 260 is capable of permanently storing contents recorded through managed copying from the recording medium 251. The external storage apparatus 260 is an HDD or a Solid State Drive (SDD), for example. In addition, a storage apparatus built in the information processing apparatus 200 may replace the external storage apparatus 260.

The power supply board 270 is a board on which a power supply circuit for supplying necessary electric power to the respective sections of the information processing apparatus 200 is mounted.

### [Functional Configuration of Information Processing Apparatus]

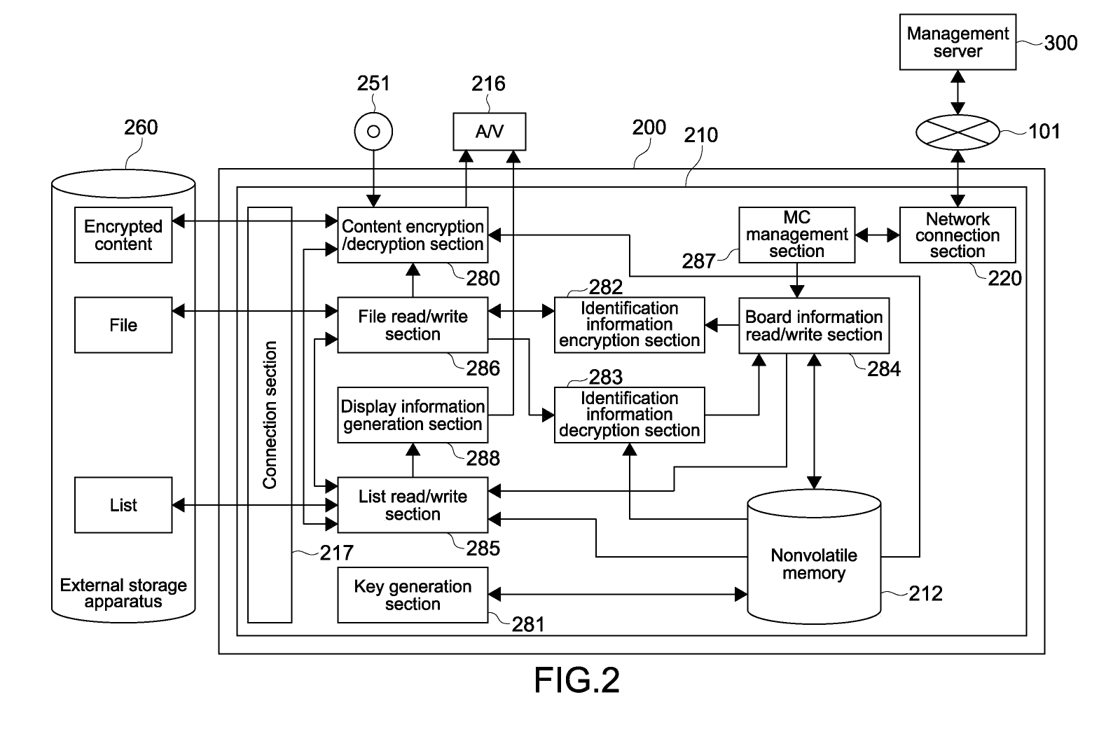

FIG. 2 is a block diagram showing a functional configuration of an information processing apparatus.

An information processing apparatus 200 includes a nonvolatile memory 212, a content encryption/decryption section 280, a key generation section 281, an identification information encryption section 282, an identification information decryption section 283, a board information read/write section 284, a list read/write section 285, a file read/write section 286, a Managed Copy (MC) management section 287, a display information generation section 288, and a connection section 217. The respective sections are implemented on the board 210.

The nonvolatile memory 212 (first to third storage sections) is capable of rewritably storing Seed A (board specific information), a device key Ka, and an apparatus serial N (apparatus specific information). The nonvolatile memory 212 further stores a board determination flag H (board determination information). The nonvolatile memory 212 further stores Seed P stored in a firmware which controls the board 210.

The Seed A (board specific information) is identification information specific to the board 210, and is generated and written when the board 210 is manufactured. The Seed A is used to generate the device key Ka specific to the board 210.

The device key Ka is used to encrypt a content recorded in a recording medium 251 or to decrypt an encrypted content, in managed copying.

It should be noted that rather than being stored in the nonvolatile memory 212, the device key Ka may be generated by the key generation section 281 from the Seed A and the Seed P at the time of set operation (when it is started or a record of managed copy content is played), stored in a memory 213, and used.

The apparatus serial N (apparatus specific information) is apparatus identification information specific to the information processing apparatus 200 which is generated and written when the information processing apparatus 200 is manufactured. The apparatus serial N is also shown as character information on a main body of the information processing apparatus 200. On the other hand, the Seed A and the device key Ka are stored only in the nonvolatile memory 212.

The Seed P is identification information specific to this firmware, that is to say, common to a generation of the information processing apparatus 200. The Seed P is used, for example, to generate a device key Ka together with the Seed A, to encrypt the Seed A to generate encrypted Seed A′ or the like. As identification information common to the generation of the information processing apparatus 200, the Seed P may also be stored as non-rewritable information in the nonvolatile memory 212 at the time of manufacturing.

The board determination flag H (board determination information) is generated when the board 210 is manufactured, and written in a one-time write area of the nonvolatile memory 212 in such a manner that it is not rewritable by users. Either H=1 or 0 is stored as the board determination flag H. With the board determination flag H=1, it is determined that the board 210 is a board 210a before replacement, that is to say, it is a board mounted on the information processing apparatus 200 when the information processing apparatus 200 was manufactured. On the other hand, with the board determination flag H=0, it is determined that the board 210 is a board 210b after replacement, that is to say, the board mounted on the information processing apparatus 200 when it was manufactured (the board 210a before replacement) was removed and the board manufactured as a replacement board (the board 210b after replacement) was newly mounted on the information processing apparatus 200. In addition, when the board 210b after replacement is mounted on the information processing apparatus 200, the board determination flag H=0 is rewritten to H=1 by the board information read/write section 284 (the processing to be described later). It should be noted that in the following description, the board 210 before being replaced will be described as “the board 210a before replacement”, and the board 210 after being replaced as “the board 210b after replacement”.

The MC management section 287 connects to the management server 300 through the network 101 by using the network connection section 220, and performs processing such as exchanging information necessary for acquiring a permission to copy a content C, with respect to the management server 300 through the network 101.

The content encryption/decryption section 280 performs managed copying or processing to play managed copied contents. To be specific, the content encryption/decryption section 280 encrypts a content C recorded in the removable recording medium 251 with the device key Ka stored in the nonvolatile memory 212, generates an encrypted content C′, and records the encrypted content C′ in the external storage apparatus 260. Further, the content encryption/decryption section 280 decrypts the encrypted content C′ recorded in the external storage apparatus 260 with the device key Ka, and generates (restores) the content C. The content encryption/decryption section 280 performs predetermined processing on the decrypted content C, and supplies it to the AV equipment 216 through the analog output terminal 214 or the digital output terminal 215. With this, the AV equipment 216 supplies the content C and users can view the content C.

The key generation section 281 performs processing such as of generating a device key Ka using the Seed A and the Seed P stored in the nonvolatile memory 212, and recording the generated device key Ka in the nonvolatile memory 212.

The identification information encryption section 282 performs processing such as of encrypting the Seed A and the apparatus serial N stored in the nonvolatile memory 212 with an apparatus common key such as the Seed P, and generating encrypted seed A′/apparatus serial N′.

The board information read/write section 284 (updating section) performs processing such as updating the board determination flag H stored in the nonvolatile memory 212 from H=0 to H=1, rewriting Seed B stored in the nonvolatile memory 212 to restored Seed A.

The list read/write section 285 (recording section) generates one list E for one external storage apparatus 260, and stores it in the external storage apparatus 260 through the connection section 217. The list read/write section 285 generates a new record in the list E, associates it with one record number, and records it, every time the content encryption/decryption section 280 records one encrypted content. The list read/write section 285 records, in the generated record, a title or date and time of recording or the like of the content C, the apparatus serial N, a path d of a file D, a path c of the encrypted content C′ (storage location), and an apparatus selection flag F (board specific information determination information).

The apparatus serial N is apparatus identification information specific to the information processing apparatus 200 where encryption of the recorded encrypted content C′ took place.

The path d is a path of the file D in which encrypted Seed A′/apparatus serial N′ is stored which results from encryption of the apparatus serial N specific to the information processing apparatus 200 where encryption of the recorded encrypted content C′ took place and of the Seed A used in generation of the device key Ka which was used in the encryption of the recorded encrypted content C′.

The path c (storage location) indicates a storage location of the encrypted content C′ recorded in the external storage apparatus 260.

The apparatus selection flag F (board specific information determination information) is a flag for identifying Seed to be used to generate a device key which is used in the encryption of the encrypted content C′, and F=0 is recorded as an initial value.

The file read/write section 286 (recording section) performs processing such as of storing the encrypted seed A′/apparatus serial N′ generated by the identification information encryption section 282 as the file D in the external storage apparatus 260 through the connection section 217, and reading through the connection section 217 the encrypted Seed A′/apparatus serial N′ from the file D stored in the external storage apparatus 260.

The identification information decryption section 283 performs processing such as of generating (restoring) the Seed A and the apparatus serial N, respectively, by decrypting the encrypted Seed A′/apparatus serial N′ read by the file read/write section 286 with the apparatus common key such as the Seed P, writing the restored Seed A in the nonvolatile memory 212.

The display information generation section 288 generates display information from the list E acquired from the list read/write section 285. The display information is listing of titles of encrypted contents recorded in the external storage apparatus 260, for example. The display information generation section 288 supplies the generated display information to the AV equipment 216 through the analog output terminal 214 or the digital output terminal 215. With this, the AV equipment 216 displays the title listing.

The external storage apparatus 260 connected to the connection section 217 is capable of recording the encrypted content C′, the file D, and the list E.

### [Process of Recording Contents in External Storage Apparatus]

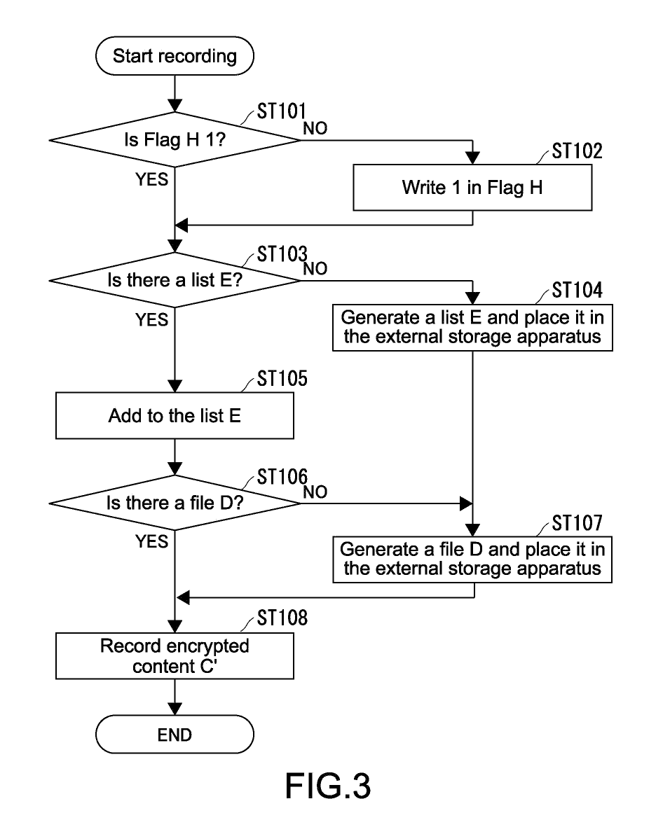

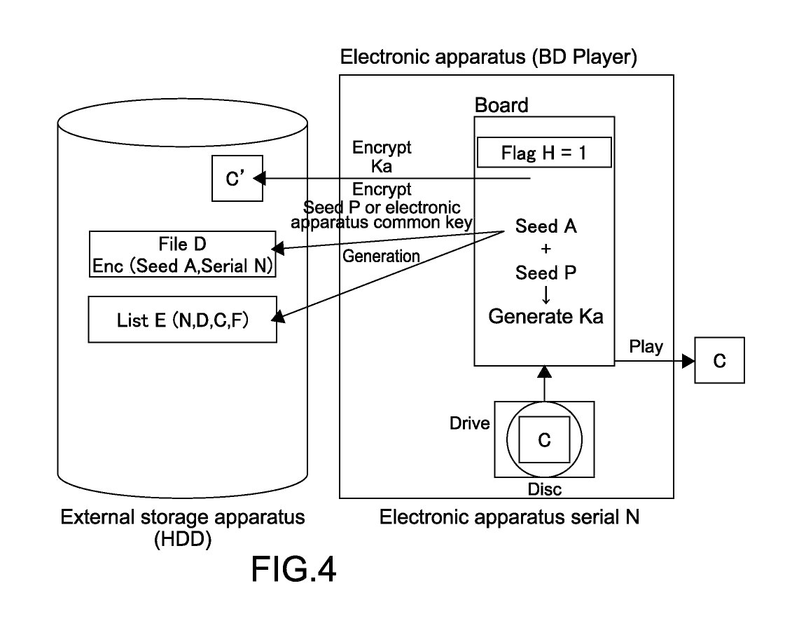

FIG. 3 is a flow chart showing a process of recording contents in the external storage apparatus. FIG. 4 is a schematic view showing the process of the recording contents in the external storage apparatus.

A nonvolatile memory 212 stores Seed A, a device key Ka, an apparatus serial N, a board determination flag H, and seed P.

In order to record a content C recorded in a recording medium 251 in the external storage apparatus 260 through managed copying, an MC management section 287 first connects through a network 101 to a management server 300, by using a network connection section 220. The MC management section 287 exchanges necessary information to acquire a permission to copy the content C with the management server 300 through the network 101. When the management server 300 acknowledges validity of the copying permission, the MC management section 287 supplies a notice of the copying permission to a board information read/write section 284.

Upon receipt of the notice, the board information read/write section 284 reads a board determination flag H stored in the nonvolatile memory 212 (step ST101). When the read board determination flag H is H=0 (NO in step ST101), the board information read/write section 284 rewrites the board determination flag H to H=1 (step ST102). The rewriting of the board determination flag to H=1 restricts subsequent rewriting of the board determination flag H to a board 210b after replacement.

When it rewrites the board determination flag H to H=1 (step ST102) or the read board determination flag H is H=1 (Yes in step ST101), the board information read/write section 284 instructs a list read/write section 285 to judge whether or not a list E is stored in the external storage apparatus 260.

Following the instruction, the list read/write section 285 judges whether or not the list E is stored in the external storage apparatus 260 (step ST103). If the list read/write section 285 judges that the list E is not stored in the external storage apparatus 260 (No in step ST103), the list read/write section 285 generates a list E and stores the list E in the external storage apparatus 260 through a connection section 217. The list read/write section 285 generates a new record by associating a new record number with the list E stored in the external storage apparatus 260 and records in the generated record a title or date and time of recording or the like of a content C to be copied, an apparatus serial N stored in the nonvolatile memory 212, a seed determination flag F=0 (initial value). The list read/write section 285 then instructs a file read/write section 286 to store a file D in the external storage apparatus 260 (step ST104).

On the other hand, when the list read/write section 285 judges that the list E is stored in the external storage apparatus 260 (Yes in step ST103), the list read/write section 285 generates a new record by associating a new record number with the list E, and records in the generated record a title or date and time of recording or the like of a content C to be copied, an apparatus serial N stored in the nonvolatile memory 212, a seed determination flag F=0 (initial value) (step ST105). The list read/write section 285 then instructs the file read/write section 286 to judge whether or not the file D is stored in the external storage apparatus 260. Following the instruction, the file read/write section 286 judges whether or not the file D is stored in the external storage apparatus 260 (step ST106).

When the file read/write section 286 judges that the file D is not stored in the external storage apparatus 260 (No in step ST106), the file read/write section 286 instructs an identification information encryption section 282 to encrypt Seed A and an apparatus serial N stored in the nonvolatile memory 212. Otherwise, following the instruction to store the file D in the external storage apparatus 260 (step ST104), the file read/write section 286 instructs the identification information encryption section 282 to encrypt the Seed A and the apparatus serial N stored in the nonvolatile memory 212.

Following the instruction, the identification information encryption section 282 generates encrypted Seed A′/apparatus serial N′ by encrypting the Seed A and the apparatus serial N stored in the nonvolatile memory 212 with an apparatus common key such as Seed P, and supplies the generated encrypted Seed A′/apparatus serial N′ to the file read/write section 286. The file read/write section 286 stores, as a file D, the encrypted Seed A′/apparatus serial N′ acquired from the identification information encryption section 282 in the external storage apparatus 260 through the connection section 217 (step ST107).

When storing the encrypted Seed A′/apparatus serial N′ as the file D in the external storage apparatus 260, the file read/write section 286 instructs a content encryption/decryption section 280 to record the content C in the external storage apparatus 260 through managed copying. In addition, the file read/write section 286 supplies to the list read/write section 285 a path d of the file D stored in the external storage apparatus 260. Otherwise, if the file read/write section 286 judges that the file D is stored in the external storage apparatus 260 (Yes in step ST106), the file read/write section 286 instructs the content encryption/decryption section 280 to record the content C in the external storage apparatus 260 through managed copying. In addition, the file read/write section 286 supplies to the list read/write section 285 the path d of the file D stored in the external storage apparatus 260.

Following the instruction, the content encryption/decryption section 280 generates an encrypted content C′ by encrypting the content C recorded in the recording medium 251 with the device key Ka stored in the nonvolatile memory 212, and records the generated encrypted content C′ in the external storage apparatus 260 (step ST108). When recording the encrypted content C′ in the external storage apparatus 260, the content encryption/decryption section 280 supplies to the list read/write section 285 a path c of the encrypted content C′ recorded in the external storage apparatus 260.

The list read/write section 285 writes in a record generated in the list E the path d of the file D acquired from the file read/write section 286 and the path c of the encrypted content C′ acquired from the content encryption/decryption section 280. Consequently, in the record generated in the list E, a title or date and time of recording or the like of the content C, the apparatus serial N, the path d, the path c, and the seed determination flag F=0 will be recorded.

It should be noted that if the encrypted content C′ thus recorded is deleted from the external storage apparatus 260, the list read/write section 285 deletes the record containing the path c of the encrypted content C′ from the list E. Consequently, when the record containing the path d is no longer in the list E, the file read/write section 286 deletes the file D indicated by the path d from the external storage apparatus 260.

### [Process of Restoring Seed A]

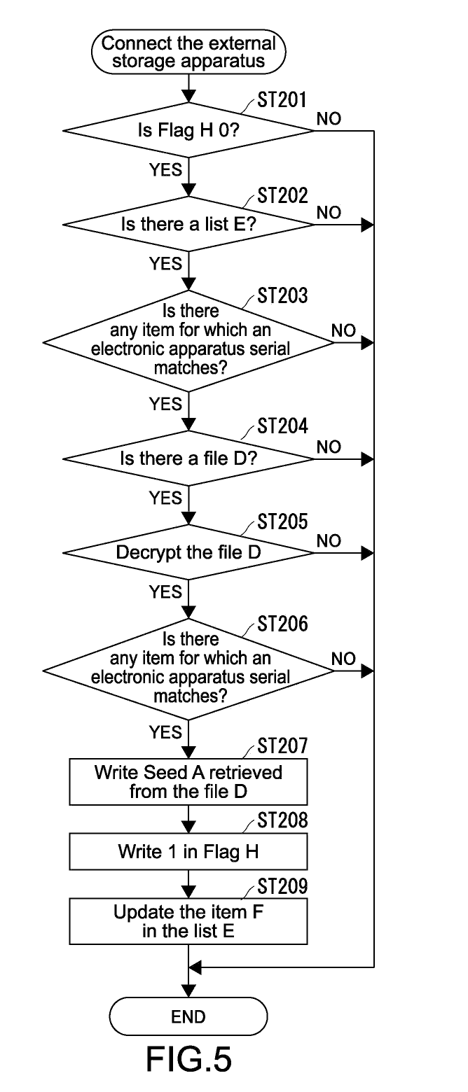

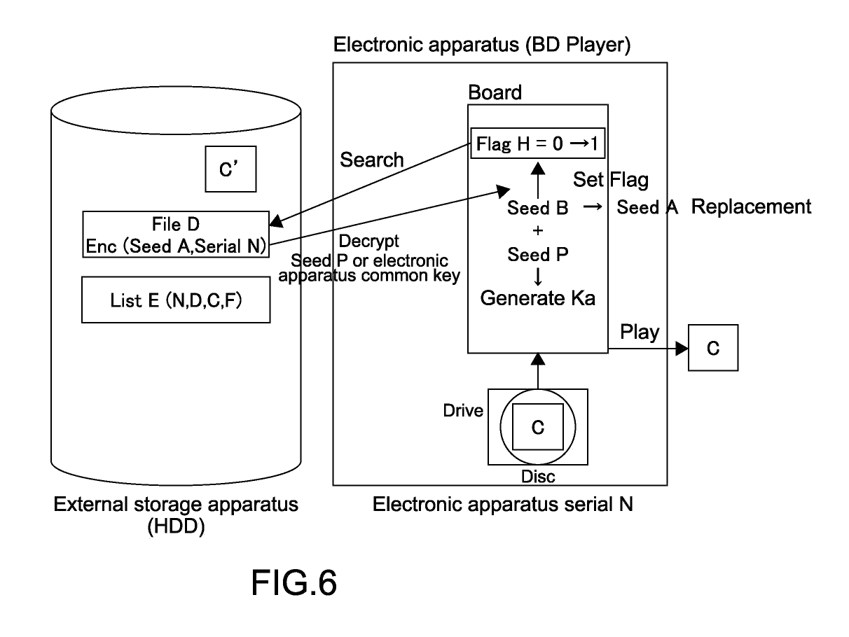

FIG. 5 is a flow chart showing a process of restoring Seed A. FIG. 6 is a schematic view showing the process of restoring the Seed A.

A board 210b after replacement is mounted on an information processing apparatus 200. In a nonvolatile memory 212 of the board 210b after replacement, Seed B, an apparatus serial N, a board determination flag H=0, and Seed P are stored.

The Seed B is identification information specific to the board 210b after replacement which is generated and rewritably written when the board 210b after replacement was manufactured.

The apparatus serial N is common to a board 210a before replacement and the board 210b after replacement. That is to say, an apparatus serial N stored in the nonvolatile memory 212 of the board 210a before replacement is written to the nonvolatile memory 212 of the board 210b after replacement by an operator of a repair factory when the information processing apparatus 200 is repaired.

The board determination flag H=0 indicates that a board 210 is the board 210b after replacement, that is to say, the board (board 210a before replacement) mounted to the information processing apparatus 200 when it had been manufactured was removed and the board (board 210b after replacement) manufactured as a replacement board was newly mounted to the information processing apparatus 200.

The Seed P is identification information specific to a firmware. The embodiment does not assume version upgrade of the firmware due to replacement of the board 210. Thus, in the following, the Seed P stored in the nonvolatile memory 212 of the board 210a before replacement and the Seed P stored in the nonvolatile memory 212 of the board 210b after replacement are the same.

On the other hand, in an external storage apparatus 260, an encrypted content C′, a file D, and a list E are recorded. The encrypted content C′, the file D, and the list E were recorded by the information processing apparatus 200 in which the board 210a before replacement is mounted, in the process of recording contents described above.

In other words, the encrypted Seed A′/apparatus serial N′ are recorded in the file D.

In the list E, a record recording a title or date and time of recording or the like of the content C, the apparatus serial N, a path d of the file D, a path c of the encrypted content C′, and a Seed determination flag F=0 is stored.

When the external storage apparatus 260 is connected to a connection section 217, a board information read/write section 284 first reads a board determination flag H stored in the nonvolatile memory 212 (step ST201). That is to say, every time the external storage apparatus 260 is connected to the connection section 217, the board information read/write section 284 reads the board determination flag H stored in the nonvolatile memory 212. When the read board determination flag H is H=0 (Yes in step ST201), the board information read/write section 284 judges that the replacement board 210b is mounted to the information processing apparatus 200, and instructs a list read/write section 285 to judge whether or not the list E is stored in the external storage apparatus 260.

Following the instruction, the list read/write section 285 judges whether or not the list E is stored in the external storage apparatus 260 (step ST202). When the list read/write section 285 judges that the list E is stored in the external storage apparatus 260 (Yes in step ST202), the list read/write section 285 judges whether or not the record containing the apparatus serial N stored in the nonvolatile memory 212 of the board 210b after replacement is recorded in the list E (step ST203). When the list read/write section 285 judges that the record containing the apparatus serial N is recorded in the list E (Yes in step ST203), the list read/write section 285 reads the path d recorded in the record containing the apparatus serial N. The list read/write section 285 instructs the file read/write section 286 to read the file D indicated by the read path d from the external storage apparatus 260.

Upon receipt of the instruction, the file read/write section 286 judges whether or not the file D indicated by the path d contained in the instruction is stored in the external storage apparatus 260 (step ST204). When the file read/write section 286 judges that the file D is stored in the external storage apparatus 260 (Yes in step ST204), the file read/write section 286 reads the encrypted Seed A′/apparatus serial N′ recorded in the file D from the external storage apparatus 260 through the connection section 217. The file read/write section 286 supplies the encrypted Seed A′/apparatus serial N′ read from the file D to an identification information decryption section 283.

The identification information decryption section 283 restores the Seed A and the apparatus serial N by decrypting the encrypted Seed A′/apparatus serial N′ with an apparatus common key such as Seed P (step ST205). If it successfully restores the Seed A and the apparatus serial N (Yes in step ST205), the identification information decryption section 283 instructs the board information read/write section 284 to rewrite the restored Seed A to the board 210b after replacement.

Upon receipt of the instruction, the board information read/write section 284 judges whether or not the apparatus serial N restored by the identification information decryption section 283 matches the apparatus serial N stored in the nonvolatile memory 212 (step ST206). If the board information read/write section 284 judges that the apparatus serial Ns match (Yes in step ST206), the board information read/write section 284 rewrites the Seed B stored in the nonvolatile memory 212 to the restored Seed A (step ST207). In other words, the board information read/write section 284 deletes the Seed B stored in the nonvolatile memory 212 and writes the restored Seed A.

Then, the board information read/write section 284 rewrites the board determination flag H=0 stored in the nonvolatile memory 212 to H=1 (step ST208). The rewriting of the board determination flag to H=1 indicates that the board 210b after replacement is mounted to the information processing apparatus 200, and restricts subsequent rewriting of the board determination flag H. When the board information read/write section 284 rewrites the board determination flag to H=1, the board information read/write section 284 instructs the list read/write section 285 to update the seed determination flag F recorded in the list E.

Following the instruction, the list read/write section 285 searches in the List E for the record recording the apparatus serial N stored in the nonvolatile memory 212 and the path d acquired from the file read/write section 286, and rewrites F=0 (initial value) to F=1 (step ST209) by adding 1 to the seed determination flag F recorded in the searched record. Consequently, it is possible to identify the seed for generating the device key Ka to perform decryption of the encrypted content C′ indicated by the path c recorded in the record which records the seed determination flag F rewritten to F=1 as the Seed A to be restored from the encrypted Seed A′/apparatus serial N′ recorded in the file D indicated by the path d.

On the other hand, when the board information read/write section 284 reads the board determination flag H=1 (No in step ST201), the process is terminated as the Seed A has already been stored in the nonvolatile memory 212. When the list read/write section 285 judges that the list E is not stored in the external storage apparatus 260 (No in step ST202), the process is terminated as no encrypted content is recorded in the external storage apparatus 260. When the list read/write section 285 judges that the record containing the apparatus serial N is not recorded in the list E (No in step ST203), the process is terminated as no encrypted content which can be viewed by the information processing apparatus 200 is recorded in the external storage apparatus 260. When the file read/write section 286 judges that the file D is not stored in the external storage apparatus 260 (No in step ST204), the process is terminated as there is a risk that the list E has been falsified or the like. When the identification information decryption section 283 fails in restoration of the Seed A and the apparatus serial N (No in step ST 205), the process is terminated as there is a risk that the file D has been falsified or the like. When the board information read/write section 284 judges that the apparatus serial N restored by the identification information decryption section 283 does not match the apparatus serial stored in the nonvolatile memory 212 (No in step ST206), the process is terminated as there is a risk that the list E has been falsified or the like.

As described above, as the Seed A has been rewritten to the nonvolatile memory 212 (step ST207), a key generation section 281 can generate a device key Ka using the restored Seed A and the Seed P stored in the nonvolatile memory 212.

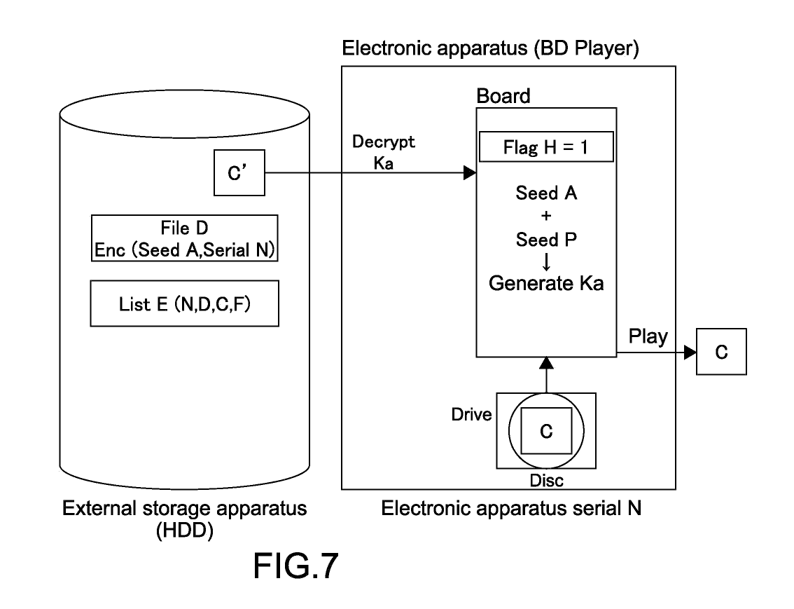

FIG. 7 is a schematic view showing a process of playing the content recorded in the external storage apparatus.

With this, the content encryption/decryption section 280 decrypts the encrypted content C′ recorded in the external storage apparatus 260 with the generated device key Ka, and generates (restores) content C. The content encryption/decryption section 280 performs predetermined processing on the decrypted content C and supplies it to the AV equipment 216 through the analog output terminal 214 or the digital output terminal 215. With this, the AV equipment 216 supplies the content and the user can view the content.

According to this embodiment, Seed A specific to the board 210a before replacement which is used to generate a device key Ka specific to the board 210a before replacement, and an apparatus serial N are associated with each other, and stored as encrypted Seed A′/apparatus serial N′ in the external storage apparatus 260. Consequently, the information processing apparatus 200 to which the board 210b after replacement is mounted can generate (restore) Seed A by decrypting the encrypted Seed A′/apparatus serial N′, and generate a device key Ka using the restored Seed A. Therefore, the information processing apparatus 200 to which the board 210b after replacement is mounted can also perform managed copying or play managed copied content by using the device key Ka specific to the board 210a before replacement. In addition, since the device key Ka itself is not stored in the external storage apparatus 260, the device key Ka will not be leaked from the information processing apparatus 200. Should the encrypted Seed A′ leak, the device key Ka may not be generated unless the encrypted Seed A′ can be decrypted and the Seed P can be acquired. Hence, it is safe.

In addition, encrypted Seed A′/apparatus serial N′ which resulted from encryption of an apparatus serial N which is a serial number specific to the information processing apparatus 200 and Seed A is stored in the external storage apparatus 260, and Seed A is stored after authentication of the apparatus serial N (step ST 206). This allows the Seed A specific to the board 210a before replacement to be restored only by the information processing apparatus 200 which is identified by the apparatus serial N. It should be noted that an apparatus serial N is not limited to a serial number to be generated and written when the information processing apparatus 200 is manufactured, but may be any identification information specific to the information processing apparatus 200.

In addition, the process of restoring Seed A starts according to the board determination flag H which the board information read/write section 284 read at the timing of connection of the external storage apparatus 260 in step ST 201. That is to say, as this eliminates a need for user operation serving as a trigger of starting the process of restoring Seed A after the board is replaced, it is highly convenient for users.

### Second Embodiment

In the following, the description of any configuration and function or the like similar to those of the first embodiment will be omitted or simplified, and differences will be mainly described.

### [Process of Restoring Seed A]

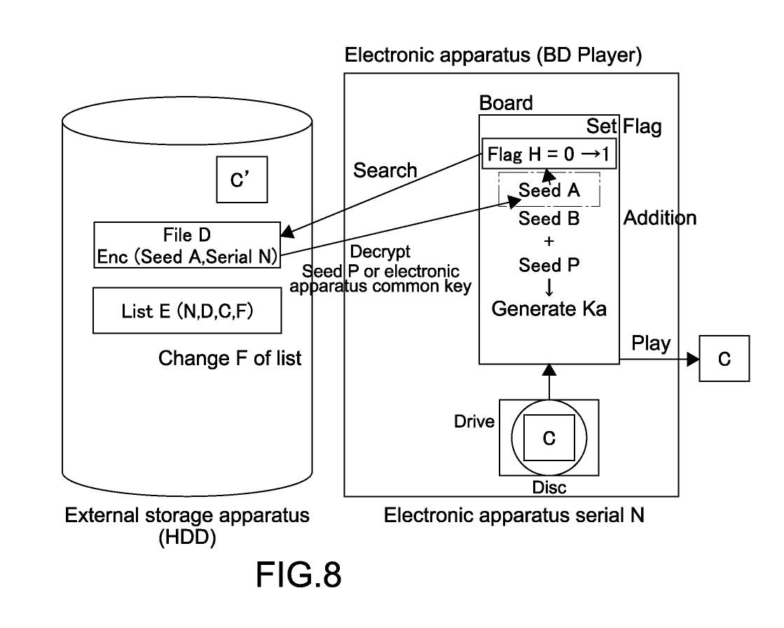

FIG. 8 is a schematic view showing a process of restoring Seed A.

The process of restoring Seed A according to a second embodiment is identical to the process of restoring the Seed A according to the first embodiment (steps ST201 to ST209), except for step ST207.

In the second embodiment, in step ST207, the board information read/write section 284 adds the restored Seed A to the nonvolatile memory 212 without deleting the Seed B stored in the nonvolatile memory 212 of the board 210b after replacement. Consequently, the Seed A and the Seed B are stored in the nonvolatile memory 212 of the board 210b after replacement.

As a result of storing of the Seed A and the Seed B in the nonvolatile memory 212, the key generation section 281 can generate a device key Ka by using the Seed A and the Seed P and store it in the nonvolatile memory 212, and generate a device key Ka2 by using the Seed B and the Seed P and store it in the nonvolatile memory 212.

Consequently, this enables decryption and playing of the encrypted content C′ which has been encrypted with the device key Ka generated by the information processing apparatus 200, to which the board 210a before replacement is mounted, using the Seed A and the Seed P and recorded in the external storage apparatus 260, with the device key Ka which has been generated using the Seed A and the Seed P restored by the information processing apparatus 200, to which the board 210b after replacement is mounted. Together with this, encrypted content Z′ encrypted with the device key Ka2 generated by the information processing apparatus 200, to which the board 210b after replacement is mounted, using the Seed B and the Seed P and recorded in the external storage apparatus 260 can be decrypted and played with the device key Ka2 by the information processing apparatus 200 to which the board 210b after replacement is mounted. Therefore, in the information processing apparatus 200 to which the board 210b after replacement is mounted can use the device key Ka only for decryption and playing of the encrypted content C′ which has been encrypted by the information processing apparatus 200 to which the board 210a before replacement is mounted, with the device key Ka and recorded in the external storage apparatus 260. Then, the device key Ka2 can be used for encryption and decryption of the content which take place after the board is replaced.

In this manner, suppose that the information processing apparatus 200 to which the board 210a before replacement is mounted performs the process of recording the content C (steps ST101 to ST108) by using the device key Ka and the information processing apparatus 200 to which the board 210b after replacement is mounted performs the process of recording the content Z (steps ST101 to ST108) by using the device key Ka2. In this case, in the external storage apparatus 260, the encrypted content C′, the file D, the list E, the encrypted content Z′, and a file Y are recorded.

The encrypted content C′ results from encryption of the content C recorded in a removable recording medium 251 with the device key Ka generated using the Seed A and the Seed P.

The file D records the encrypted Seed A′/apparatus serial N′ which results from encryption, with the apparatus common key such as the Seed P or the like, of the Seed A and the apparatus serial N which were used to generate the device key Ka.

A predetermined record in the list E records a title or date and time of recording or the like of the content C, the apparatus serial N, the path d of the file D, the path c of the encrypted content C′, and the seed determination flag F=1. The seed determination flag F=1 was updated in the above step ST209.

On the other hand, the encrypted content Z′ results from encryption of the content Z recorded in the removable recording medium 251 with the device key Ka2 generated using the Seed B and the Seed P.

The file Y records the encrypted Seed B′/apparatus serial N′ which resulted from encryption, with the apparatus common key such as the Seed P or the like, of the Seed B and the apparatus serial N which were used to generate the device key Ka2.

Another record in the list E records a title or date and time of recording or the like of the content Z, the apparatus serial N, a path y of the file Y, a path z of the encrypted content Z′, and the seed determination flag F=0 (initial value).

### [Process of Restoring Content Recorded in the External Storage Apparatus]

As described above, the process of decrypting and playing an encrypted content in an information processing apparatus 200 which decrypts and plays encrypted contents C′, Z′ which were encrypted with a plurality of device keys Ka, Ka2 will be described.

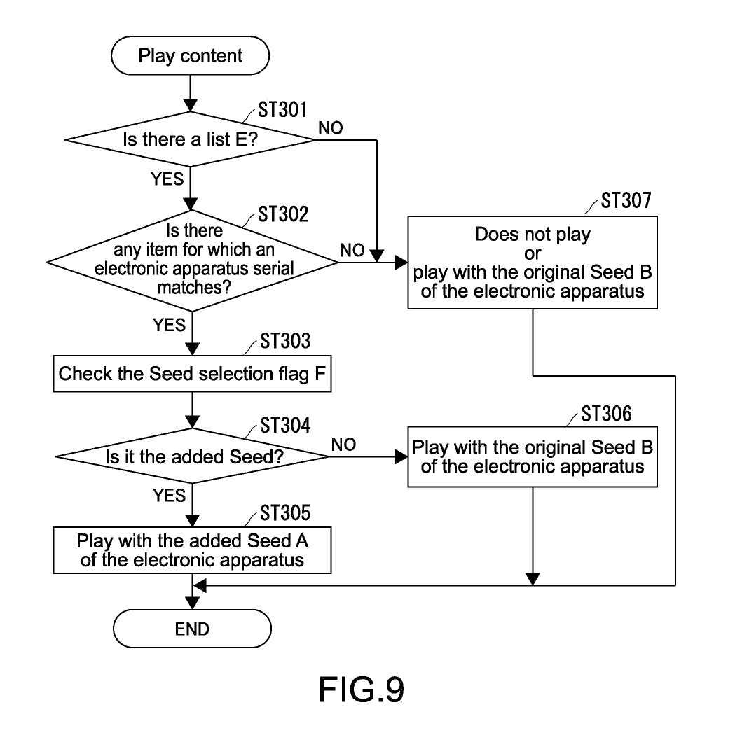

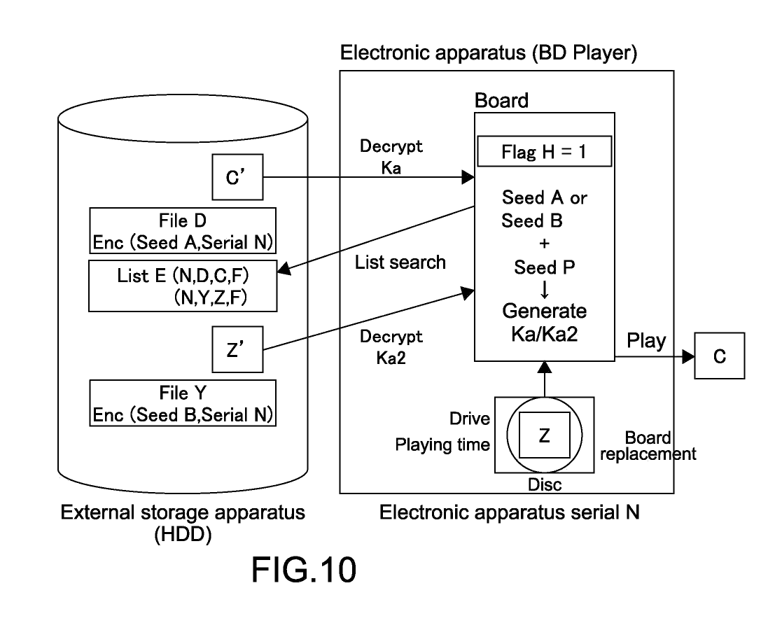

FIG. 9 is a flow chart showing the process of playing the content recorded in the external storage apparatus. FIG. 10 is a schematic view showing the process of playing the content recorded in the external storage apparatus.

A board 210b after replacement is mounted to the information processing apparatus 200. In a nonvolatile memory 212 of the board 210b after replacement, Seed A, Seed B, a device key Ka, a device key Ka2, an apparatus serial N, a board determination flag H=1, and Seed P are stored.

For the Seed A and the Seed B, in the process of restoring seed described above, the Seed B is not deleted by a board information read/write section 284 and restored Seed A is added to the nonvolatile memory 212.

The device key Ka is generated by a key generation section 281 by using the Seed A and Seed P which are restored through the process of restoring Seed A (steps ST201 to ST209) described above.

The device key Ka2 is generated by the key generation section 281 by using the Seed B and the Seed P stored in the nonvolatile memory 212 of the board 210b after replacement.

The board determination flag H=1 results from rewriting of the board determination flag H=0 stored in the nonvolatile memory 212 to H=1 by a board information read/write section 284 in the above step ST208.

On the other hand, in the external storage apparatus 260, the encrypted content C′ described above, a file D, a list E, the encrypted content Z′, and a file Y are recorded in the process of recording contents (steps ST101 to ST108).

When a user enters a request for selection of a content to be played by using an input operation section 230, a list read/write section 285 reads the list E from the external storage apparatus 260 and supplies it to a display information generation section 288. The display information generation section 288 generates display information from the list E acquired from the list read/write section 285. The display information is listing of titles of encrypted contents recorded in the external storage apparatus 260. A title in the listing is each associated with a record number. The display information generation section 288 supplies the generated display information to AV equipment 216 through an analog output terminal 214 or a digital output terminal 215. With this, the AV equipment 216 displays the title listing.

By referring to the title listing displayed on the AV equipment 216 and selecting a title of content to be played by using the input operation section 230, the user instructs playing of the content indicated by the record number associated with the title. The record number associated with the selected title is supplied to the list read/write section 285.

For example, suppose that the user instructs playing of the content C indicated by the record number R1 and that the record number R1 is supplied to the list read/write section 285.

When acquiring the record number, the list read/write section 285 judges whether or not the list E is stored in the external storage apparatus 260 (step ST301). If the list read/write section 285 judges that the list E is stored in the external storage apparatus 260 (Yes in step ST301), the list read/write section 285 judges whether or not a record containing an apparatus serial N stored in the nonvolatile memory 212 of the board 210b after replacement is recorded in the list E (step ST302).

In this embodiment, the list E records 2 records containing the apparatus serial N. One record records a title or date and time of recording or the like of the content C, the apparatus serial N, a path d, a path c, and a seed determination flag F=1. In this record, the record number R1 is associated and recorded. The other record records a title or date and time of recording or the like of the content Z, the apparatus serial N, a path y, a path z, and a seed determination flag F=0. In the record, a record number R2 is associated and recorded.

If the list read/write section 285 judges that the record containing the apparatus serial N is recorded in the list E (Yes in step ST302), the list read/write section 285 reads the record indicated by the acquired record number R1, of the records containing the apparatus serial N. That is to say, the list read/write section 285 reads a record indicated by a record number associated with a title of a content to be played.

The list read/write section 285 reads the seed determination flag F recorded in this record (step ST303), and judges whether or not the read seed determination flag F has been rewritten (step ST304). For example, the list read/write section 285 reads the seed determination flag F=1 from the record indicated by the record number R1.

When the read seed determination flag F is F=1 or higher (Yes in step ST304), the list read/write section 285 recognizes that the process of restoring the Seed A has been performed and the seed determination flag F has been rewritten in step ST209. This reveals that the encrypted content C′ indicated by the path c recorded in the record indicated by the record number R1 was encrypted with the device key Ka generated using the Seed A.

If it judges the seed determination flag is F=1 or higher, the list read/write section 285 notifies a content encryption/decryption section 280 that the seed determination flag is F=1 or higher. Upon receipt of the notice, the content encryption/decryption section 280 acquires from the nonvolatile memory 212 the device key Ka generated using the Seed A which is indicated by the seed determination flag of F=1 or higher. The content encryption/decryption section 280 decrypts the encrypted content C′ recorded in the external storage apparatus 260 with the device key Ka, and generates (restores) the content C (step ST305). The content encryption/decryption section 280 performs predetermined processing on the decrypted content C, and supplies it to the AV equipment 216 through the analog output terminal 214 or the digital output terminal 215. With this, the AV equipment 216 supplies the content C and the user can view the content C.

On the other hand, suppose that the user instructs playing of the content Z indicated by the record number R2 by using the input operation section 230 and that the record number R2 is supplied to the list read/write section 285.

When the list read/write section 285 judges that the record containing the apparatus serial N is recorded in the list E (Yes in step ST302), the list read/write section 285 reads the record indicated by the acquired record number R2, of the records containing the apparatus serial N. The list read/write section 285 reads the seed determination flag F=0 from the records indicated by the record number R2 (step ST303).

When the read seed determination flag F is F=0 (No in step ST304), the list read/write section 285 learns that the encrypted content Z′ indicated by the path z recorded in the record indicated by the record number R2 was encrypted by the device key Ka2 generated using the Seed B.

If the list read/write section 285 judges that the seed determination flag is F=0, the list read/write section 285 notifies the content encryption/decryption section 280 of the seed determination flag F=0. Upon receipt of the notice, the content encryption/decryption section 280 acquires from the nonvolatile memory 212 the device key Ka2 generated using the Seed B indicated by the seed determination flag F=0. The content encryption/decryption section 280 decrypts the encrypted content Z′ recorded in the external storage apparatus 260 with the device key Ka2, and generates (restores) the content Z (step ST306). The content encryption/decryption section 280 performs predetermined processing on the decrypted content Z, and supplies it to the AV equipment 216 through the analog output terminal 214 or the digital output terminal 215. With this, the AV equipment 216 supplies the content Z and the user can view the content Z.

On the other hand, when the list read/write section 285 judges that the list E is not stored in the external storage apparatus 260 (No in step ST301), the list read/write section 285 does not perform playing or attempts decryption with the device key Ka2 generated using the Seed B specific to the board 210b after replacement (step ST307) as no encrypted content is recorded in the external storage apparatus 260. If the list read/write section 285 judges that the record containing the apparatus serial N is not recorded in the list E (No in step ST302), the list read/write section 285 does not perform playing or attempts decryption with the device key Ka2 generated using the Seed B specific to the board 210b after replacement (step ST307), as no encrypted content which can be viewed by the information processing apparatus 200 is recorded in the external storage apparatus 260.

According to this embodiment, the encrypted content C′ indicated by the path c associated with the apparatus serial N stored in the nonvolatile memory 212 is decrypted with the device key Ka generated with the Seed A to be identified on the basis of the seed determination flag F associated with the path c, to restore the content C. In this manner, as Seed on which a device key is based can be identified on the basis of the seed determination flag F even if one information processing apparatus 200 includes a plurality of device keys Ka, Ka2, the device key can be appropriately selected when decrypting an encrypted content.

The present disclosure contains subject matter related to that disclosed in Japanese Priority Patent Application JP 2010-132385 filed in the Japan Patent Office on Jun. 9, 2010, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An information processing apparatus, comprising:
a board on which a plurality of electronic components are provided;
a connection section to which an external storage apparatus is detachable;
a content encryption section which is provided on the board and generates an encrypted content by encrypting a content with a device key;
a first storage section which is provided as one of the electronic components on the board and stores board determination information for determining whether the board is a board at the time of shipment or a replacement board;
a second storage section which is provided as one of the electronic components on the board and is capable of storing board specific information which is specific to the board and used to generate the device key;
a third storage section configured to store apparatus specific information which is specific to the information processing apparatus;
a recording section configured to associate the board specific information and the apparatus specific information each other and record the board specific information and the apparatus specific information through the connection section in the external storage apparatus connected to the connection section; and
an updating section configured to read from the external storage apparatus connected to the above connection section the board specific information associated with the apparatus specific information stored in the third storage section, and update content of the second storage section and the board determination information of the first storage section, when the board is determined to be the replacement board on a basis of the board determination information stored in the first storage section.

2. The information processing apparatus according to claim 1, wherein
the updating section makes a determination on a basis of the board determination information stored in the first storage section of the board, every time the external storage apparatus is connected.

3. The information processing apparatus according to claim 2, wherein
the recording section encrypts the board specific information and the apparatus specific information, and records the board specific information and the apparatus specific information as one file in the external storage apparatus.

4. The information processing apparatus according to claim 3, wherein
the updating section overwrites the second storage section with second board specific information, with the board specific information stored in the second storage section being as first board specific information and the board specific information read from the external storage apparatus by the updating section being as the second board specific information.

5. The information processing apparatus according to claim 3, wherein
the updating section adds second board specific information to the second storage section, with the board specific information stored in the second storage section being as first board specific information and the board specific information read from the external storage apparatus by the updating section being as the second board specific information.

6. The information processing apparatus according to claim 5, wherein
the content encryption section records the encrypted content through the connection section in the external storage apparatus connected to the connection section,
the recording section associates a storage location of the encrypted content, flag information for identifying the board specific information used in generation of the device key used in generation of the encrypted content, and the apparatus specific information specific to the information processing apparatus which generates the encrypted content together, and records the storage location, the flag information, and the apparatus specific information through the connection section in the external storage apparatus connected to the connection section, for each of encrypted contents stored in the external storage apparatus, and
the information processing apparatus further comprises an encrypted content decryption section configured to decrypt the encrypted content stored in the storage location associated with the apparatus specific information which is stored in the third storage section with the device key which is generated by using the board specific information to be identified on a basis of the flag information associated with the storage location, and restores the content.

7. An information processing method by an information processing apparatus including a board on which a plurality of electronic components are provided, a connection section to which an external storage apparatus is detachable, a content encryption section which is provided on the board and generates an encrypted content by encrypting a content with a device key, a first storage section which is provided as one of the electronic components on the board and stores board determination information for determining whether a board is a board at the time of shipment or a replacement board, a second storage section which is provided as one of the electronic components on the board and is capable of storing board specific information which is used to generate the device key and specific to the board, and a third storage section configured to store apparatus specific information specific to the information processing apparatus, the method comprising:
associating the board specific information and the apparatus specific information each other and recording the board specific information and the apparatus specific information through the connection section in the external storage apparatus connected to the connection section, by a recording section; and
reading from the external storage apparatus connected to the connection section the board specific information associated with the apparatus specific information stored in the third storage section, and updating content of the second storage section and the board determination information of the first storage section, by an updating section, when the board is determined to be the replacement board on a basis of the board determination information stored in the first storage section.

8. A program causing an information processing apparatus including a board on which a plurality of electronic components are provided, a connection section to which an external storage apparatus is detachable, a content encryption section which is provided on the board and generates an encrypted content by encrypting a content with a device key, a first storage section which is provided as one of the electronic components on the board and stores board determination information for determining whether a board is a board at the time of shipment or a replacement board, a second storage section which is provided as one of the electronic components on the board and is capable of storing board specific information which is used to generate the device key and specific to the board, and a third storage section configured to store apparatus specific information specific to the information processing apparatus, to function as:
a recording section configured to associate the board specific information and the apparatus specific information each other and record the board specific information and the apparatus specific information through the connection section in the external storage apparatus connected to the connection section; and
an updating section configured to read from the external storage apparatus connected to the connection section the board specific information associated with the apparatus specific information stored in the third storage section, and to update content of the second storage section and the board determination information of the first storage section, when the board is determined to be the replacement board on a basis of the board determination information stored in the first storage section.
